(19) United States
(12) Patent Application Publication
(10) Pub. No.: US 2016/0230926 A1
(43) Pub. Date: Aug. 11, 2016

(54) System for wall-mounting of objects

(71) Applicant: Harry Don Marley, JR., Rogers, AR (US)

(72) Inventor: Harry Don Marley, JR., Rogers, AR (US)

(21) Appl. No.: 14/544,697

(22) Filed: Feb. 5, 2015

(51) Int. Cl. F16M 13/02; A47G 1/16

(52) U.S. Cl. CPC F16M 13/02; A47G 1/1606

(57) ABSTRACT

A system for wall-mounting an object comprising a wall hanger having a plurality of rivets protruding therefrom, and a back plate formed to mate with the wall hanger rivets via a like plurality of keyhole openings. An optional pre-formed frame is receptive of the object and the back plate; may be formed of wood, plastic, or metal; has an opening on the front side; and may be relieved at its rear side to provide a relief for receiving the object and an optional pane of glass and the back plate. A spacer may be included between the object and the back plate. The back plate is attached to the frame conventionally. Where the back plate extends outboard of the relief, the frame may be further relieved locally to obviate interference of the frame with the wall hanger rivet heads extending through the back plate keyhole openings.

### RELATIONSHIP TO OTHER APPLICATIONS AND PATENTS

This application is a Continuation-In-Part from a pending U.S. patent application Ser. No. 13/694,947, filed Jan. 22, 2013, which is incorporated herein in its entirety by reference.

### TECHNICAL FIELD

The present invention relates to systems for mounting objects on walls; and more particularly, to a system comprising a wall-mountable component and an object assembly component matable with the wall-mountable component.

### BACKGROUND OF THE INVENTION

In numerous applications in the arts of displaying objects, it is desired to mount an object for view or use on a vertical surface. (For simplicity, a “vertical surface” is herein referred to also as a “wall”, and the term “object” wherever used herein should be taken to mean any object, e.g., a preformed frame, a mirror, signage, art work, picture, painting, print, sculpture, cabinet, shelves, or the like, that is intended to be mounted via the present invention on a vertical surface.)

In any non-adhesive strategy for mounting an object to a wall, the weight of the object must be carried on at least one attachment device that penetrates into the wall.

A simple method and apparatus for mounting an object to a wall is simply to drive attachment devices such as nails or screws through the object into the wall. However, this approach can be unsatisfactory for at least the following reasons:
1. the attachment devices can cause damage to the object;
2. the attachment devices are readily accessible, so the object can be readily removed, and hence stolen; and
3. the attachment devices can be unsightly and therefore detract from the aesthetic appeal of the object.

What is needed in the art is a wall-mounting system wherein a first element comprising a utilitarian wall hanger serves to secure the system to a wall via one or more attachment devices and a second element comprising the object to be wall-mounted is secured to and covers the first element.

It is a principal object of the present invention to mount an object on a wall without damaging the object.

It is a further object of the present invention to mount an object on a wall such that the attachment devices are neither accessible nor visible at completion of mounting.

It is a still further object of the present invention to mount on a wall an object selected from the group consisting of a pre-formed frame, signage, art work, picture, painting, print, sculpture, cabinet, and shelves.

It is a still further object of the present invention to mount on a wall an object such that the object cannot readily be stolen or accidentally dislodged.

### SUMMARY OF THE INVENTION

Briefly described, a system in accordance with the present invention for wall-mounting an object comprises a wall-mountable wall hanger and an object assembly. The present invention provides a simple, fast wall-mounting system of an object that is easy to install, theft resistant, and covers the attachment devices.

In a first exemplary embodiment of a wall hanger, a preferably rectangular structure, formed of sheet metal and having a wall-proximal side and a wall-distal side, includes a flat-head semi-tubular shoulder rivet (herein referred to as a “rivet”) protruding outward from the wall-distal side near each of the four corners of the rectangle. The rivets are deformed by compression during assembly of the structure to be substantially flush with the wall-proximal side.

In a first exemplary embodiment of an object assembly to be mated with a wall hanger, a frame formed of wood, plastic, glass, rubber, metal, or combinations thereof is first provided as a starting element of the assembly. Such a frame may be formed in accordance with any prior art. The frame has an opening on the front side for display of the object surrounded by three or more side elements, preferably four. Each of the side elements, preferably although not necessarily, is relieved at its rear side to provide a relief for receiving from the rear the object and optionally a pane of glass and a back plate attached to the frame by any conventional apparatus. Where the back plate is not fitted within the relief but extends outboard thereof, the frame may be further relieved locally via a plurality of cavities to obviate interference of the frame with the rivets extending through the back plate.

In a second exemplary embodiment of an object assembly, an object to be wall mounted without a frame, such as a small cabinet or shelving, is relieved locally via cavities as in the first embodiment, and the back plate is attached directly to the object as by screws, bolts, or adhesive.

### BRIEF DESCRIPTION OF THE DRAWINGS

The present invention will now be described, by way of example, with reference to the accompanying drawings, in which:

FIG. 1 is an exploded side assembly view of a system in accordance with the present invention for wall-mounting an object, showing a wall hanger component matable with an object assembly component;

FIG. 2 is a plan view of the wall hanger component shown in FIG. 1;

FIG. 3 is an elevational cross-sectional view of a currently-preferred rivet prepared for installation into a wall hanger frame between an anvil and a hammer of a high-impact mechanical press;

FIG. 4 is an elevational cross-sectional view of the rivet shown in FIG. 3 after installation into a wall hanger structure;

FIG. 5 is a plan view of a currently preferred embodiment of a one-piece back plate for use in the object assembly component shown in FIG. 1;

FIG. 6 is a cross-sectional view of a first embodiment of a complete object assembly component of wall-mounting system in accordance with the present invention;

FIG. 7 is a cross-sectional view of a second embodiment of a complete object assembly component of a wall-mounting system in accordance with the present invention; and

FIG. 8 is a cross-sectional view of a third embodiment of a complete object assembly component of a wall-mounting system in accordance with the present invention.

Corresponding reference characters indicate corresponding parts throughout the several views. The exemplifications set out herein illustrate currently preferred embodiments of the invention, and such exemplifications are not to be construed as limiting the scope of the invention in any manner.

### DETAILED DESCRIPTION OF THE PREFERRED EMBODIMENTS

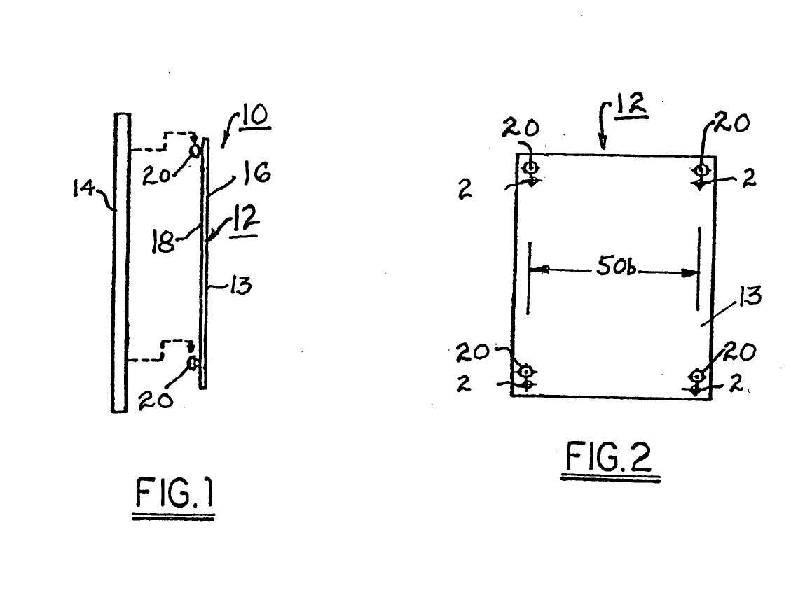

Referring to FIGS. 1 through 8, a theft-proof wall-mounting system 10 comprises a wall-mountable component such as wall hanger 12 and an object assembly component 14.

Wall hanger 12 comprises a preferably rectangular structure 13 formed of sheet metal having a wall-proximal side 16 and a wall-distal side 18. Headed rods 20, preferably deformed headed rivets, protrude from side 18 near each of the four corners of structure 13. Adjacent each headed rod 20 is a precision-punched hole 21 in structure 13 for mounting the wall hanger to a wall via screws (not shown).

In a currently preferred embodiment, each headed rod 20 is a flat-head semi-tubular shoulder rivet (also referred to herein as a “headed rivet”) having a flat head 22 and a shank having a solid-rod shouldered portion 24, a shoulder 26, and a semi-tubular deformable portion 28.

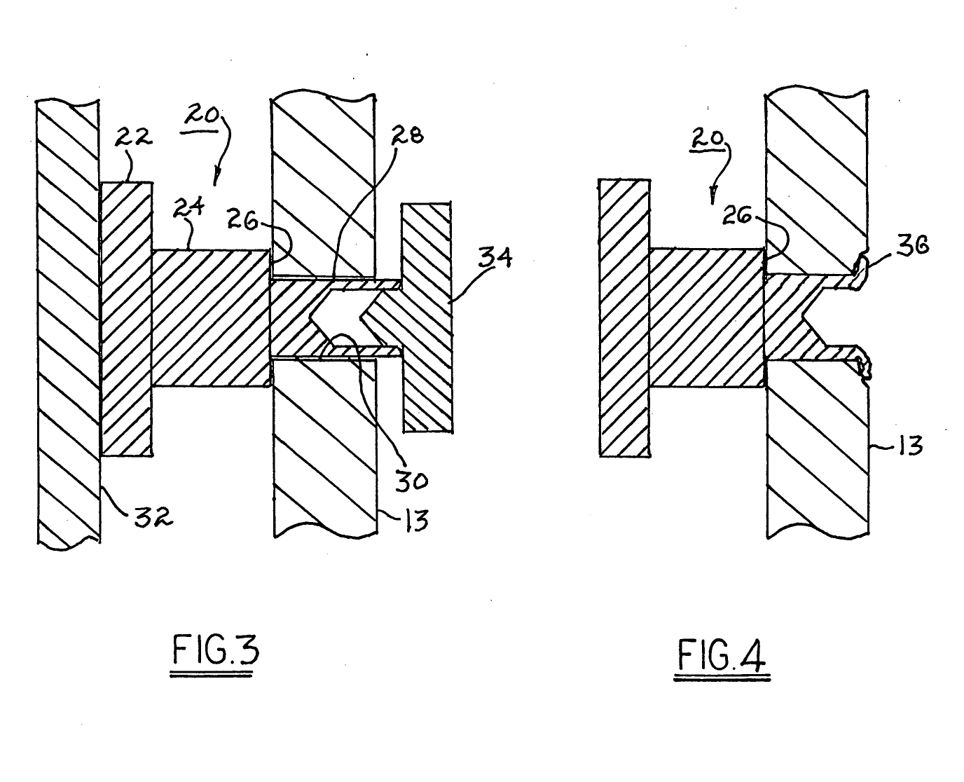

In a method for forming wall hanger 12, four precision-punched holes 30 are formed in structure 13 adjacent holes 22, respectively, each hole 30 having a diameter preferably about 0.002″ larger than the diameter of rivet portion 28. A headed rivet 20 is installed into each hole 30 between an anvil 32 and hammer 34 of a high-impact mechanical press, as shown in FIG. 3. Actuation of the press serves to roll and deform the open end of portion 28 outward, thereby firmly securing the headed rivet in structure 13 between shoulder 26 and rolled end 36, as shown in FIG. 4.

It has been found that forming protruding elements 20 of solid rod is an important element of the invention. To withstand the downward force exerted by gravity on a mounted object assembly, these protruding elements incorporate metallic deformation of the element as by riveting or welding on the wall-proximal side of structure 13. The just-described flat-head semi-tubular shoulder rivet, formed from solid rod stock in known fashion, has been found to be a simple and convenient solution, preferable to welding of rod.

A threaded fastener screwed into hole 30 rather than using a welded rod or semi-tubular shoulder rivet is an inferior and unacceptable arrangement, and is not within the comprehension of the present invention, because it does not provide adequate lateral stability or strength and is prone to sagging or pulling out of the hole under load. It appears that having a portion of the rod stock, e.g., rolled end 36, deformed on the wall-proximal side 16 of structure 13 serves to direct the load imposed by a mounted object assembly downward within structure 13, minimizing the torque imposed on rod portion 24. Such deformation cannot be obtained with a non-deformed threaded fastener.

During mounting of object assembly 14 onto wall hanger 12, deformed headed rivets 20 mate with keyhole openings 38 formed in back plate 40 of object assembly 14. It is a vital element of the present invention that each rivet 20 be deformed and thereby fixedly attached to metal structure 13 of wall hanger 12.

In operation, wall hanger 12 is easily and quickly leveled and mounted in known fashion, which leveling guarantees that object assembly 14 will be level. Object assembly 14 is hung on wall hanger 12 by a) positioning object assembly 14 with rivets 20 extending through respective keyhole openings 38 and b) sliding object assembly 14 downwards to capture rivet heads 22 at the narrow ends 42 of keyhole openings 38. A locking tab 44 having a slot 46 is pivotably mounted on back plate 40 and is provided with a string 48 extending beyond the edge of back plate 40. After object assembly 14 is mounted on wall hanger 12, c) string 48 is pulled by an installer to pivot locking tab 44 and thereby engage slot 46 with an adjacent rivet 20 under its rivet head 22, thereby preventing object assembly 14 from being raised and removed from wall hanger 12. String 48 is then cut flush with the edge of object assembly 14 and discarded. Preferably, string 48 is provided as a loop such that the entire string may be removed from locking tab 44 after the loop has been severed.

Object assembly 14 may be removed from wall hanger 12 by insertion of any thin tool, e.g., a plumber's tool, plaster blade, or scraper, (not shown) between back plate 40 and wall hanger 12, pivoting locking tab 44 out of locking engagement, raising object assembly 14, and pulling object assembly 14 away from the wall to clear rivet heads 22.

Note that the spacing 50a between the left and right keyhole openings 38 is controlled and precisely set to be identical to the spacing 50b between the left and right rivets 20 on matable wall hanger 12 which is manufactured specifically for the dimensions of object assembly 14. Thus, in the present invention, wall hanger 12 and back plate 40 are manufactured as a matable set having identical and fixed spacing between left and right rivets and left and right keyhole openings, so that a matable set may be applied to the hanging of a wide range of objects having differing width and height dimensions, as described below.

Referring to FIG. 6, a first embodiment 114 of an object assembly in accordance with the present invention comprises optionally a glass window 116, an object 118 such as a picture for display, a backing sheet 120, at least one back plate 122, and a pre-formed frame 124.

Frame 124 may be formed in accordance with any prior art and has an opening 126 on the front side to permit viewing of object 118 surrounded by three or more sides (not shown), preferably four. Each side is relieved at its rear 128 to provide a relief 130 for receiving object 118, optional glass window 116, backing sheet 120, and back plate 122. Back plate 122 is attached to frame 124 by any conventional apparatus 132, e.g., bead of silicone, adhesive, tape, glazier points, brads, screws, or the like. When mounted to a matable wall hanger 12, keyhole openings 38 open onto adjacent backing sheet 120 which may be compressible (e.g., expanded polystyrene) to accommodate rivet heads 22 during mounting of object assembly 114 onto a wall hanger 12. Alternatively, as shown in FIG. 6, one or more cavities 134 in backing sheet 120 may be provided to accommodate one or more rivet heads 22.

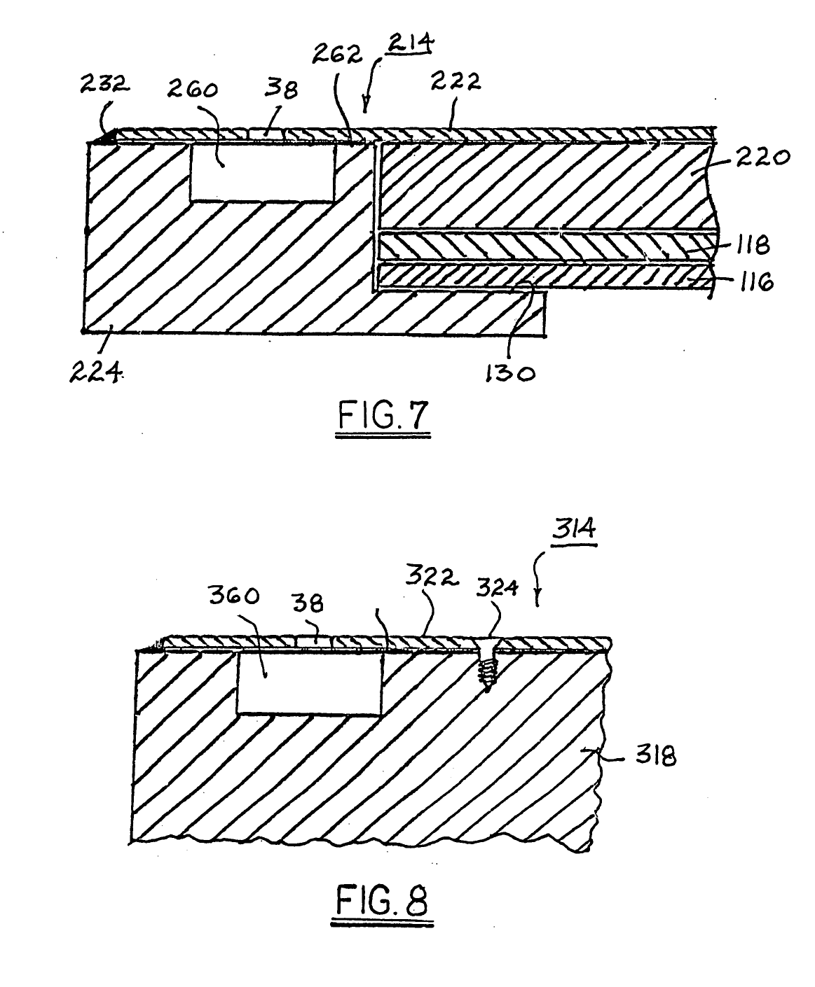

Referring to FIG. 7, a second embodiment 214 of an object assembly is similar to first embodiment 114 except that preformed frame 224 is wide enough that keyhole openings 38 are adjacent frame 224 rather than backing sheet 220. Thus, a separate cavity 260 is provided in the rear surface 262 of frame 224 to accommodate a rivet head 22 during mounting of object assembly 214 onto a wall hanger 12. As in first embodiment 114, one-piece back plate 222 is attached to frame 224 by any conventional apparatus 232.

Referring now to FIG. 8, in a third embodiment 314 an object 318 to be wall-hung, e.g., shelving or a cabinet, does not require any framing but rather is mounted directly onto one-piece back plate 322 as by screws 324 or other conventional attachment means. As in embodiment 214, a cavity 360 is provided in the rear surface 362 of object 318 to accommodate a rivet head 22 during mounting of object assembly 314 onto wall hanger 12.

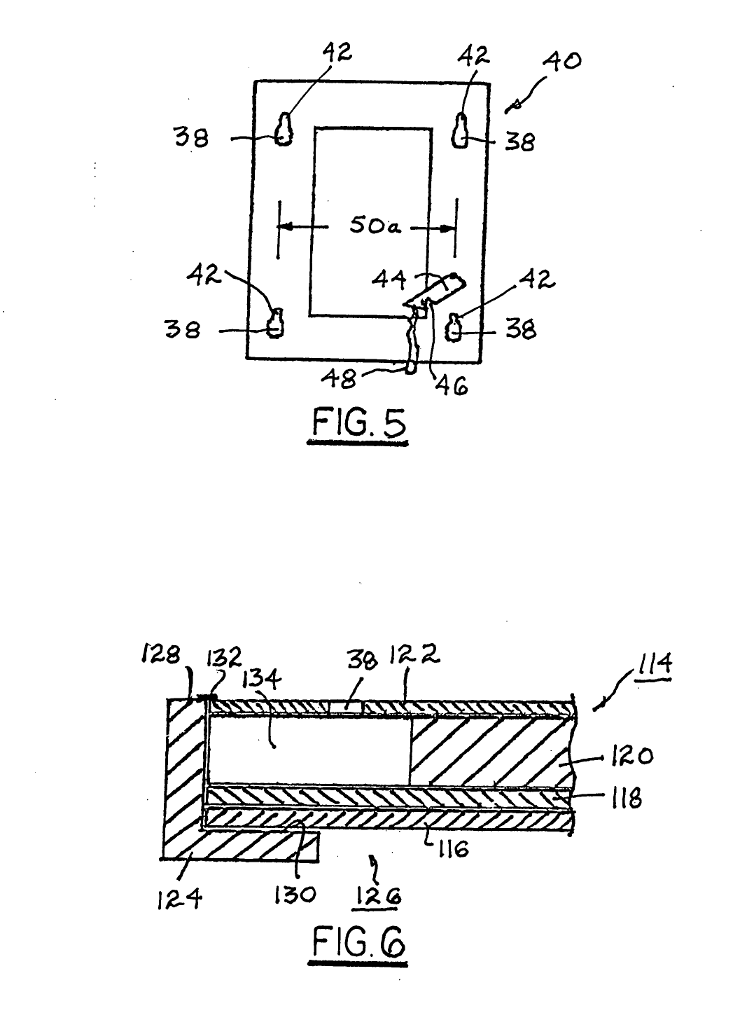

In embodiments 114, 214, and 314, each back plate 122, 222, 322 further comprises a pivotable locking tab 44, as described above and shown in FIG. 5.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for wall-mounting of an object, comprising:
a) a wall hanger having a plurality of fixed and headed solid rod elements protruding from a metal structure, wherein said fixed and headed solid rod elements have been deformed after insertion into a plurality of holes in said metal structure; and
b) an object assembly including said object to be mounted on said plurality of deformed headed solid rod elements,
wherein said object assembly includes a pre-formed frame,
wherein said object assembly includes a back plate having a plurality of keyhole openings matable with said plurality of deformed headed solid rod elements, and
wherein said wall hanger and said back plate are manufactured as a matable set having identical and fixed spacing among said plurality of fixed and headed solid rod elements and said plurality of keyhole openings.

2. A system in accordance with claim 1 wherein said solid rod elements are selected from the group consisting of solid rod and headed rivets.

3. A system in accordance with claim 2 wherein said headed rivets are flat-head semi-tubular shoulder rivets.

4. A system in accordance with claim 1 wherein said object is selected from the group consisting of signage, artwork, mirror, picture, painting, print, sculpture, cabinet, and shelves.

5. A system in accordance with claim 1 wherein said back plate includes a pivotable locking tab.

6. A system in accordance with claim 1 wherein said pre-formed frame is formed from a material selected from the group consisting of wood, plastic, metal, glass, rubber, and combinations thereof.

7. A system in accordance with claim 1 wherein said pre-formed frame includes a relief formed in the rear thereof for receiving said object.

8. A system in accordance with claim 7 wherein said back plate is receivable within said relief.

9. A system in accordance with claim 7 wherein said back plate extends over a rear surface of said pre-formed frame, and wherein a cavity is formed in said rear surface for receiving a head of a headed rivet.

10. A system for wall-mounting of an object, comprising:
a) a wall hanger having a plurality of fixed and headed solid rod elements protruding from a metal structure, wherein said fixed and headed solid rod elements have been deformed after insertion into a plurality of holes in said metal structure; and
b) an object assembly including said object to be mounted on said plurality of deformed headed solid rod elements,
wherein said object assembly includes a back plate having a plurality of keyhole openings matable with said plurality of deformed headed solid rod elements, and
wherein said wall hanger and said back plate are manufactured as a matable set having identical and fixed spacing among said plurality of fixed and headed solid rod elements and said plurality of keyhole openings.

11. A method for forming an object assembly for use with a wall hanger having a plurality of deformed headed rivets protruding therefrom, comprising the steps of:
a) providing a back plate having a plurality of keyhole openings matable with said plurality of deformed headed rivets;
b) providing a pre-formed frame;
b) forming a relief in a rear surface of said frame;
c) placing said object within said relief;
d) installing said back plate onto said frame to capture said object within said frame; and
e) securing said back plate to said frame.

12. A method in accordance with claim 11 wherein said back plate is accommodated within said relief.

13. A method in accordance with claim 11 wherein said back plate extends over a portion of said rear surface, further comprising the step of forming a cavity in said rear surface for receiving a head of a headed rivet.

14. A method in accordance with claim 11 comprising the further step of installing a sheet of glass within said relief.

15. A method for forming a wall hanger for use with an object assembly, comprising the steps of:
a) providing a metal structure having a wall-proximal side and a wall-distal side;
b) forming at least one hole through said metal structure;
c) inserting a flat-head semi-tubular shoulder rivet into said hole from said wall-distal side; and
d) deforming said flat-head semi-tubular shoulder rivet in said hole from said wall-proximal side to secure said deformed rivet to said metal structure.

16. A method in accordance with claim 15,
wherein said metal structure is rectangular, and
wherein said at least one hole is formed near a first corner of said rectangular metal structure.

17. A method in accordance with claim 15 further comprising the steps of:
a) forming at least one additional hole through said rectangular metal structure near an additional corner thereof, wherein said at least one additional hole has a placement with respect to its respective corner identical with the placement of said at least one hole;
b) inserting an additional flat-head semi-tubular shoulder rivet into each of said at least one additional hole from said wall-distal side; and
c) deforming each said additional flat-head semi-tubular shoulder rivet from said wall-proximal side to secure said each additional flat-head semi-tubular shoulder rivet to said rectangular metal structure.
